(19) United States
(12) Patent Application Publication
(10) Pub. No.: US 2002/0017250 A1
(43) Pub. Date: Feb. 14, 2002

(54) Device for artificially inseminating sows in particular

(76) Inventor: Bertrand Cassou, Saint Symphorien Des Bruyeres (FR)

Correspondence Address: YOUNG & THOMPSON, 745 SOUTH 23RD STREET 2ND FLOOR, ARLINGTON, VA, 22202

(21) Appl. No.: 09/875,049

(22) Filed: Jun. 7, 2001

(30) Foreign Application Priority Data
Jun. 8, 2000 (FR) 0007347
Sep. 11, 2000 (FR) 0011525

(51) Int. Cl. A01K 13/00; A62B 35/00

(52) U.S. Cl. 119/858; 119/850

(57) ABSTRACT

An artificial insemination device for artificially inseminating sows in particular includes a saddle which is placed on the back of a female. A support on the saddle supports a sachet containing animal semen and holds the sachet in a globally vertical position. A constant pressure applicator associated with the sachet maintains the animal semen contained in the sachet at a constant pressure

### BACKGROUND OF THE INVENTION

1. Field of the Invention

The present invention relates to artificial insemination devices, more particularly suitable for breeding sows, of the kind including a saddle adapted to be placed on the back of a female and provided with support means for a sachet containing animal semen.

2. Description of the Prior Art

An artificial insemination device of the kind mentioned above and suitable for so-called “gravity” artificial insemination, which does not require the continuous presence of the operator throughout the period of insemination, is known in the art; the sachet of semen is attached to the saddle and connected to an insemination probe inserted in the neck of the uterus of the female to be inseminated.

A known advantage of this kind of device is that it facilitates detecting when the animal is on heat. If the female is not yet ovulating, it generally attempts to get rid of the saddle by lying down or shaking itself; it is therefore sufficient to place this kind of device on the female and observe its behavior; if it tolerates the saddle, then the sachet of animal semen is installed and insemination is allowed to proceed by natural flow of the semen due to the effect of gravity and uterine contractions that aspirate the semen; while this is happening the operator can carry out other inseminations.

This kind of device is described in the document FR-A-2 720 929 and in French patent application 99 11433 filed Sep. 13, 1999, for example.

It is often recommended to apply to the sachet containing the semen a pressure slightly greater than that resulting from gravity alone, in particular when inseminating young nulliparous sows; however, to prevent backflow and the attendant risks of loss of fertility or prolificity, the pressure must not be too high.

The document FR-A-2 720 929 cited above also proposes to associate with the sachet containing the semen an empty sachet connected to an inflation member consisting of a stethoscope bulb, for example.

This has drawbacks; on the one hand, it is not easy to adjust the pressure; on the other hand, the pressure falls as the semen flows into the uterus of the animal.

An object of the present invention is to avoid these drawbacks.

### SUMMARY OF THE INVENTION

The invention provides an artificial insemination device for artificially inseminating sows in particular, the artificial insemination device including a saddle adapted to be placed on the back of a female, a support on the saddle adapted to support a sachet containing animal semen and to hold the sachet in a globally vertical position, and a constant pressure applicator adapted to be associated with the sachet to maintain the animal semen contained in the sachet at a constant pressure.

The constant pressure is advantageously adjustable.

The sachet is preferably made from a flexible material, advantageously from a transparent flexible material, and the constant pressure applicator consists of a weighted clamp adapted to seal the sachet hermetically, to form an air bubble above the level of the animal semen contained in the sachet, and to slide along the sachet under its own weight as the level of the animal semen falls in the sachet as insemination proceeds as the result of uterine contractions of the animal.

In a preferred embodiment the clamp includes two rollers adapted to rotate about two parallel axles extending over at least the whole of the width of the sachet and to press two walls of the sachet together in a sealed manner.

The constant pressure is advantageously adjusted by calibrating the rollers.

The support on the saddle preferably includes an arm adapted to have the sachet suspended from its end; the arm preferably carries two hooks adapted to be passed through at least one pair of holes in the sachet; the hooks are preferably fixed to the end of the arm; the hooks can instead be mounted on the arm so that they can slide along the arm.

The hooks are advantageously carried by an elastic clip fitted tightly around the arm so that its position along the arm is adjustable.

The saddle is advantageously rigid.

The saddle advantageously has a base adapted to rest on the back of the female; the base is a plate or a stainless wire.

The base carries, in addition to the arm, a globally U-shaped transverse clip whose sides are bent and adapted to grip elastically the flanks of the female; the clip is made from bent wire; the wire comprises two strands at least parts of which are globally parallel.

The sides of the clip advantageously comprise practically straight sections connected at a sharp angle with no radiusing.

The base is preferably fixed.

The base is advantageously formed by extending and deforming the wire constituting the clip.

Alternatively, the base is rotatably mounted on the saddle; the base is in the form of a wire loop articulated to the clip.

The arm is advantageously articulated to the saddle; the arm is adapted to occupy at least two positions, one of which is a storage position; the arm is adapted to occupy at least two different insemination positions.

The invention will be better understood and other advantages will become more clearly apparent in the light of the following description of an artificial insemination device in accordance with the principle of the invention, which description is given by way of example only and with reference to the accompanying drawings.

### BRIEF DESCRIPTION OF THE DRAWINGS

FIG. 1 is a general perspective view showing a sow being inseminated by means of a device in accordance with the invention.

FIG. 2 repeats part of FIG. 1 to a larger scale.

FIGS. 3 and 4 are perspective views showing a variant of the device with the arm in two different positions.

FIGS. 5 and 6 show parts of the device shown in FIGS. 3 and 4, respectively, to a larger scale.

FIG. 7 is a perspective view of a variant of the device.

FIG. 8 is a plan view of the device shown in FIG. 7 in a storage configuration.

### DETAILED DESCRIPTION OF THE PREFERRED EMBODIMENTS

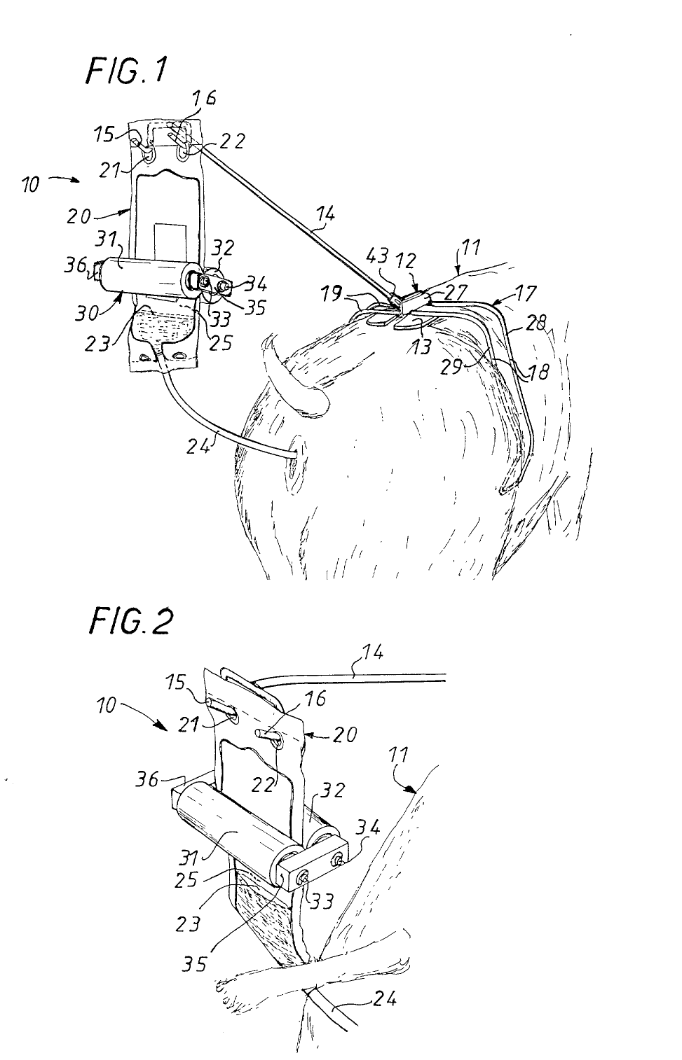

FIGS. 1 and 2 show a sow 11 being artificially inseminated using a device 10.

The device 10 includes a rigid saddle 12 placed on the back of the female 11.

The saddle 12 has a base 13 resting directly on the back of the female 11.

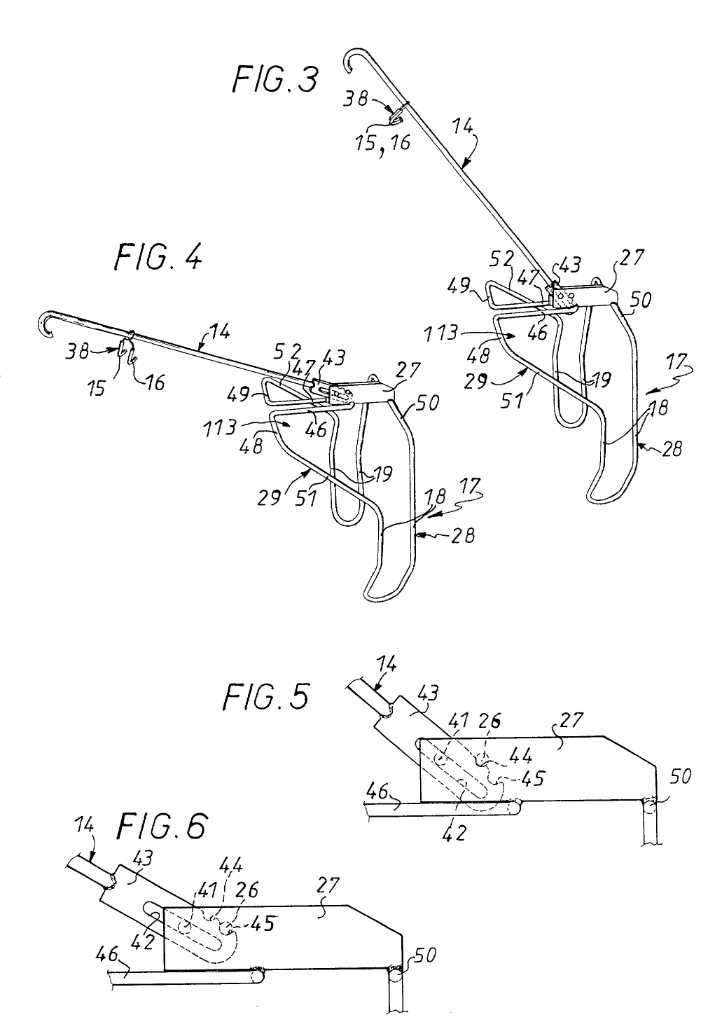

An arm 14 is inclined toward the rear, for example at 450°, when the device is in place; its free end is shaped like a rake with two tines, each in the form of a respective hook 15, 16; the arm 14 is made of stainless wire, rigid and approximately 5 mm in diameter. It is advantageously articulated by means of a small plate 43 at its end to a bracket 27 on the saddle 12 and to which the base 13 and a clip 17 are fastened directly; this articulation means that the arm can be folded, which facilitates storage of the insemination device 10; the bracket 27 has two flanges with the small plate 43 of the arm 14 between them; the arm 14 can occupy several positions, as described below with reference to FIGS. 3 to 6.

The clip 17 of the saddle 12 is globally U-shaped with the sides slightly bent so that it can firmly encompass both flanks of the female 11.

To be more precise, the clip 17 is bent to shape from wire, for example 5 mm diameter stainless wire; the sides 18, 19 of the U-shape are doubled back on themselves so that the wire has two globally parallel strands 28, 29 spaced apart by a distance of a few tens of millimeters, for example.

The sides 18, 19 are slightly bent inward and imitate as far as possible the front hooves of a boar, and therefore its embrace, which makes it possible to verify if the female is receptive to insemination, stimulates the female and causes discharge of ocytocin, which results in uterine contractions; this kind of clip 17 envelops the belly of the female securely, without it being necessary to strap it on, and ensures that the device is stable.

Obviously, the rigid saddle 12 can be washed and sterilized.

The sachet 20 is a flexible sachet of transparent plastics material formed of two films constituting the walls of the sachet and welded together; its transparency enables visual control of artificial insemination; the weld defines a peripheral edge; at one end at least of the peripheral edge there are two lateral holes 21, 22 forming eyelets on respective opposite sides of the sachet; the sachet 20 is of the type described in U.S. Pat. No. 5,971,971, for example.

The distance between the hooks 15, 16 on the arm 14 is substantially equal to the distance between the centers of the holes 21, 22 so that the sachet 20 can be suspended from the arm 14 by these holes, as can be seen in the figures; in this position the sachet 20 is globally vertical.

The hooks 15, 16 are oriented toward the rear in this embodiment, relative to the animal; they could instead extend toward the front.

Means for applying a constant pressure associated with the sachet 20 include a weighted clamp 30 fitted around the sachet 20; in the embodiment shown, the clamp 30 includes two rollers 31, 32 which rotate on two parallel axles 33, 34; the length of the rollers 31, 32 is greater than the width of the sachet 20, so that the rollers extend beyond the sachet by about 10 millimeters on each side, for example.

The axles 33, 34 are supported laterally at their ends on bars 35, 36. The rollers 31, 32 are made from a rubber-like material or at least carry an elastomer coating, advantageously a flexible elastomer coating, so that when the sachet 20 is introduced between them they press the walls of the sachet 20 together in a sealed manner; the rubber-like material also adheres to the plastics material walls and the clamp 30 can therefore move up or down the sachet 20, in accordance with positive or negative uterine contractions, as described below.

The device in accordance with the invention is used in the following manner.

With the female 11 wearing the saddle 12, the clamp 30 is fitted to the sachet 20 by inserting the top part of the sachet 20 between the rollers 31, 32 of the clamp 30; the rollers 31, 32 pinch the walls of the sachet 20 and descend along them to a level above the level 23 of the semen contained in the sachet 20; the air trapped in the sachet 20 is therefore confined in a pocket 25 defined between the level 23 of the semen and the generatrices of the cylinders 31, 32 in mutual contact; the sachet 20 is then suspended from the hooks 15, 16 on the arm 14 by its holes 21, 22.

In this position of the sachet 20, the pressure of the air in the pocket 25 depends on the weight of the clamp 30, which can be calibrated: it is sufficient to provide a set of clamps 30 of different weights, e.g. equipped with rollers of different weights, staggered by 50 g to 1000 g, for example, to adapt the pressure and/or the insemination time to different sows, for example of different breeds; the pressure is moderated and controlled in this way.

A probe 24 is then introduced in the conventional way into the bottom part of the sachet 20 and into the neck of the uterus of the female 11.

Clearly, as the semen descends into the uterus of the female 11, i.e. as uterine contractions occur, the rollers 31, 32 descend the sachet 20, the air pocket 25 pushing down the semen, the pressure in it remaining constant, of course, during inward contractions of the uterus of the female; during outward contractions, the rollers 31, 32 rise up the sachet 20, pushed up by the rising pocket of air 25, which is in turn pushed up by the semen; movement of the clamp 30 is clearly perfectly synchronized with the contractions of the uterus of the female 11.

Thanks to the device according to the invention, insemination is simple, efficient and can be controlled visually; it is no longer a question of forcible injection, as in some prior art methods; here it is the onset of uterine contractions, indicating that the animal is on heat, that initiates movement of the clamp 30.

Because the device in accordance with the invention does not come into contact with the uterus or the animal semen, it can be used again without cleaning it; there is no risk of contamination or genetic mixing; made of flexible material, it is compact.

Note also that the elastic clip 17 of the device 10 clamps the flanks of the female 11, so stimulating uterine contractions.

FIGS. 3 to 6 show a variant of the device according to the invention.

Here, instead of being in the form of a plate, as in the previous embodiment, the base 113 is formed by extending and deforming the strand 29 of the wire constituting the sides 18 and 19 of the clip 17; the free ends of the wire and its middle part are joined, for example welded, to the bracket 27, which has two vertical flanges linked by a pin 41 on which the arm 14 pivots by means of a slot 42 in the small plate 43; to be more precise, the base 113 is defined by two sections 46, 47 aligned with the flanges of the bracket 27 and connected, here at right angles, to two sections 48, 49 axially aligned with each other; the sections 46-47-48-49 are coplanar, as is also the middle part 50 of the U-shaped strand 28; oblique sections 51, 52 connect the sections 48, 49 to the remainder of the strand 29 of the sides 18, 19.

Notches of different depth are provided at the rear end of the top edge of the small plate 43; in this example there are two notches 44 and 45, spaced in the direction of the arm 14 and adapted to cooperate with a pin 26 carried by the base 27 between its two flanges.

The arm 14 can therefore assume different inclinations, as can be seen in FIGS. 3 and 5, on the one hand, and in FIGS. 4 and 6, on the other hand, enabling the sachet 20 to be placed in an ideal, so-called insemination position corresponding to the nulliparous or multiparous female to be inseminated. In FIGS. 3 and 5, the shallower notch 44 cooperates with the pin 26 and in FIGS. 4 and 6 the deeper notch 45; in these latter figures, the arm 14 is inclined farther toward the rear.

As can be seen, the various positions of the arm 14 are obtained without any demounting.

The length of the slot 42 is such that by pulling the arm 14 outward the small plate 43 can be disengaged completely from the pin 26; the arm 14 can then be folded completely down, passing between the sections 46 and 47 to lie inside the clip 17, parallel to the sides 18, 19, in a storage configuration.

When the device 10 is fitted to an animal, a so-called rest position of the arm 14 can be obtained by pivoting the arm 14 completely toward the front of the animal until the small plate 43 cooperates with the pin 26.

Everything just stated with reference to the base shown in FIGS. 3 to 6 is valid for that shown in FIGS. 1 and 2, in which the base is in the form of a plate and has a notch open toward the rear for the arm to pass through.

Here the hooks 15, 16 are carried by an elastic clip 38 which fits tightly around the arm 14 so that its position along the arm can be varied and can be chosen so that insertion of the probe 24 is facilitated and so that the probe extends from the sachet in a globally parabolic line, which encourages the flow of semen.

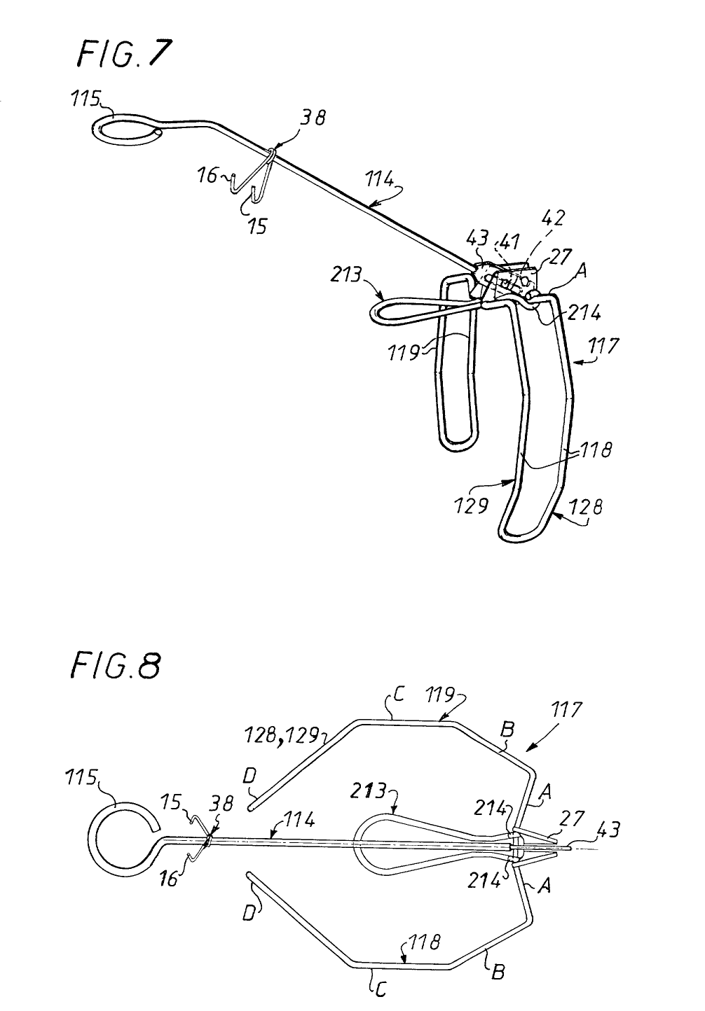

FIGS. 7 and 8 show another embodiment of a device according to the invention.

In these figures, components identical to or having the same function as those of the previous embodiments carry the same reference numbers increased by 100 or 200.

Here the clip 117 is of the kind shown in FIG. 1, and is made from wire bent to shape, the sides 118, 119 being doubled back on themselves, the wire having two generally parallel strands 128, 129 that are spaced by 6 mm or 7 mm, for example. The sides 118, 119 are also bent inward; here each of them has four practically straight sections A, B, C, D with an obtuse angle between successive sections (see FIG. 8); note that the joins are abrupt, the wire being bent with no radiusing, which avoids deformation of the sides 118, 119 in use and consequential reduction of the spring effect which applies pressure to the flanks of the animal.

Here the base 213 is in the form of an elongate open loop of wire articulated to the clip 117; to be more precise, the ends 214 (FIG. 7) of the open loop are wound around virtually horizontal segments A of the strand 128 of the sides 118, 119; the base 213 stabilizes the saddle in the operational position; in this position, shown in FIG. 7, the base 213 is under the bracket 27 and under the strand 129 of the side 118, 119 which is the rear strand relative to the animal; also, the base 213 is under the arm 114, and therefore toward the rear of the animal; in this position, the base 213 prevents the saddle tilting and sliding toward the rear because of the weight of the sachet 20 and the clamp 30; also, the elongate open loop shape of the base 213 enables it to straddle the spine of the animal, which locates and immobilizes the saddle transversely.

Here the arm 114 has its free end in the form of a ring 115 to facilitate grasping it.

There is claimed:

1. An artificial insemination device for artificially inseminating sows in particular, said artificial insemination device including a saddle adapted to be placed on the back of a female, a support on said saddle adapted to support a sachet containing animal semen and to hold said sachet in a globally vertical position, and a constant pressure applicator adapted to be associated with said sachet to maintain said animal semen contained in said sachet at a constant pressure.

2. The artificial insemination device claimed in claim 1 wherein said constant pressure is adjustable.

3. The artificial insemination device claimed in claim 1 wherein said sachet is made from a flexible material and said constant pressure applicator consists of a weighted clamp adapted to seal said sachet hermetically, to form an air bubble above the level of said animal semen contained in said sachet, and to slide along said sachet under its own weight as the level of said animal semen falls in said sachet as insemination proceeds as the result of uterine contractions of said animal.

4. The artificial insemination device claimed in claim 3 wherein said clamp includes two rollers adapted to rotate about two parallel axles extending over at least the whole of the width of said sachet and to press two walls of said sachet together in a sealed manner.

5. The artificial insemination device claimed in claim 2 wherein said clamp includes two rollers adapted to rotate about two parallel axles extending over at least the whole of the width of said sachet and to press two walls of said sachet together in a sealed manner and said constant pressure is adjusted by calibrating said rollers.

6. The artificial insemination device claimed in claim 4 wherein each of said two rollers carries a flexible covering.

7. The artificial insemination device claimed in claim 1 wherein said support on said saddle includes an arm adapted to have said sachet suspended from its end.

8. The artificial insemination device claimed in claim 7 wherein said arm carries two hooks adapted to be passed through at least one pair of holes in said sachet.

9. The artificial insemination device claimed in claim 8 wherein said hooks are fixed to the end of said arm.

10. The artificial insemination device claimed in claim 8 wherein said hooks are mounted on said arm so that they can slide along said arm.

11. The artificial insemination device claimed in claim 10 wherein said hooks are carried by an elastic clip fitted tightly around said arm so that its position along said arm is adjustable.

12. The artificial insemination device claimed in claim 1 wherein said saddle is rigid.

13. The artificial insemination device claimed in claim 1 wherein said saddle has a base adapted to rest on the back of said female.

14. The artificial insemination device claimed in claim 13 wherein said base is a plate.

15. The artificial insemination device claimed in claim 13 wherein said base is a stainless wire.

16. The artificial insemination device claimed in claim 13 wherein said base carries, in addition to said arm, a globally U-shaped transverse clip whose sides are bent and adapted to grip elastically the flanks of said female.

17. The artificial insemination device claimed in claim 16 wherein said clip is made from bent wire.

18. The artificial insemination device claimed in claim 17 wherein said wire comprises two strands at least parts of which are globally parallel.

19. The artificial insemination device claimed in claim 16 wherein said sides comprise practically straight sections connected at a sharp angle with no radiusing.

20. The artificial insemination device claimed in claim 13 wherein said base is fixed.

21. The artificial insemination device claimed in claim 17 wherein said base is a stainless wire and is formed by extending and deforming said wire constituting said clip.

22. The artificial insemination device claimed in claim 13 wherein said base is rotatably mounted on said saddle.

23. The artificial insemination device claimed in claim 22 wherein said support on said saddle includes an arm adapted to have said sachet suspended from its end and said base is in the form of a wire loop articulated to said clip.

24. The artificial insemination device claimed in claim 7 wherein said arm is articulated to said saddle.

25. The artificial insemination device claimed in claim 24 wherein said arm is adapted to occupy at least two positions, one of which is a storage position.

26. The artificial insemination device claimed in claim 25 wherein said arm is adapted to occupy at least two different insemination positions.

27. The artificial insemination device claimed in claim 3 wherein said sachet is made from a transparent material.
